(19) United States
(12) Patent Application Publication
(10) Pub. No.: US 2016/0252121 A1
(43) Pub. Date: Sep. 1, 2016

(54) EXPANSION ANCHOR WITH SPRING ELEMENT

(71) Applicant: HILTI AKTIENGESELLSCHAFT, Schaan (LI)

(72) Inventors: Peter Gstach, Schaan (LI); Bernhard Winkler, Feldkirch (AT); Patrick Scholz, Buchs (CH)

(21) Appl. No.: 15/030,765

(22) PCT Filed: Oct. 14, 2014
(86) PCT No.: PCT/EP2014/071962

§ 371 Date: Apr. 20, 2016

(30) Foreign Application Priority Data
Oct. 22, 2013 (EP) 13189656.5

(51) Int. Cl. F16B 13/06; F16B 43/00

(52) U.S. Cl. CPC F16B 13/066; F16B 43/00

(57) ABSTRACT

An expansion anchor for anchoring in a drilled hole in a substrate, including a bolt with a front end and a rear end opposite the front end, an expansion sleeve arranged on the bolt, an expansion cone pressing the expansion sleeve radially outward when the expansion cone is displaced in an extraction direction relative to the expansion sleeve, a counter bearing for axially pressing an attachment part to the substrate, and arranged in the region of the rear end of the bolt, and a spring element arranged on the bolt for axially tensioning the counter bearing against the attachment part. The axial spring force F of the spring element lies in the range from Fₘᵢₙ<Fₘₐₓ where Fₘᵢₙ=dₘₐₓ×0.2 kN/mm−0.8 kN Fₘₐₓ=dₘₐₓ×0.6 kN/mm if the spring element is axially slackened 0.4 mm to 0.8 mm from its maximum spring deflection.

The present invention relates to an expansion anchor for anchoring in a drilled hole in a substrate. An expansion anchor of this type is equipped with a bolt having a front end and a rear end opposite the front end, an expansion sleeve situated on the bolt, an expansion cone, which is situated in the area of the front end of the bolt and which pushes the expansion sleeve radially outwardly when the expansion cone is displaced in an extraction direction relative to the expansion sleeve, in particular together with the bolt, a counter bearing for axially pressing an attachment part against the substrate, which is situated on the bolt in the area of the rear end of the bolt, and a spring element, which is situated on the bolt, in particular in the area of the rear end of the bolt, for the purpose of axially pretensioning the counter bearing, and preferably also the bolt, against the attachment part.

### BACKGROUND

An expansion anchor having a spring element is known, for example from DE 33 31 097 A1. It has a spring element between its counter bearing, which is designed as a screw head, and the substrate, in which the anchor is set. This spring element may partially maintain the pretension in the bolt of the expansion anchor if the substrate is relaxed over the course of several hours and days after the anchor is set.

Other expansion anchors having spring elements are known from DE 30 22 011 A1. This publication teaches the dimensioning of the spring element in such a way that it is fully compressed, i.e., its deformation path is exhausted, upon reaching the predetermined setting force of the anchor or a predetermined fraction thereof. The spring element may thus be used as a visual setting force indicator.

### SUMMARY OF THE INVENTION

An object of the present invention is to provide a particularly reliable expansion anchor, which has particularly good load values, in particular in cracked concrete, and which simultaneously has a particularly simple and cost-effective design.

The present invention provides an expansion anchor, the axial spring force F of the spring element is in the range of Fₘᵢₙ<F<Fₘₐₓ, where

Fₘᵢₙ=dₘₐₓ×0.2 kN/mm−0.8 kN

Fₘₐₓ=dₘₐₓ×0.6 kN/mm

when the spring element is axially slackened 0.4 mm to 0.8 mm from its maximum spring deflection, i.e., if the following applies to spring deflection s of the spring element:

(sₘₐₓ−0.8 mm)<s<(Sₘₐₓ−0.4 mm),

dₘₐₓ being a maximum diameter of the bolt between the expansion cone and the counter bearing, and sₘₐₓ being the maximum spring deflection. The unit designation “kN” represents, in the usual way, the unit kilonewton, and the unit designation “mm” represents millimeters.

The present invention is based on experiments carried out using expansion anchors in cracked concrete. If a concrete crack in which the expansion anchor is located opens up to a width which is typical for a structure, for example from 0.3 mm to 0.5 mm, the pretensioning force in the bolt drops off, since the expansion cone, and thus the bolt, typically moves 0.4 mm to 0.8 mm in the extraction direction, and the spring element, which may be present, slackens by a corresponding distance. This drop in pretensioning force may result in a reduced anchoring and may thus have negative consequences for the load characteristics of the anchor and, in particular, result in an undesirable displacement of the anchor if the crack repeatedly opens and closes. After all, as the pretensioning force decreases, to 0 kN in the extreme case, the expansion effect diminishes, and the expansion tabs of the expansion sleeve may detach from the drilled hole wall in the extreme case.

On this basis, the present invention proposes a spring element having a special spring characteristic curve in the load displacement diagram. In this special spring characteristic curve, the remaining residual spring force F is in a predefined range between Fₘᵢₙ and Fₘₐₓ when the spring element has initially reached its maximum spring deflection sₘₐₓ during the setting of the anchor, and the spring element has subsequently slacked by the distance typical for cracked concrete, from 0.4 mm to 0.8 mm, particularly if a crack opens.

The present invention has determined that, with the aid of a spring element dimensioned according to the present invention, sufficiently high residual pretensions may be maintained under typical conditions in cracked concrete, so that the above-described negative effect of a crack opening may be avoided to the greatest possible extent. In particular, it has been observed experimentally that using a spring element of this type, in spring-free anchor systems, improvements by approximately one load class may be achieved in cracked concrete and/or a load increase of approximately 25% may be achieved. In addition, the present invention has determined that, using the provided parameters, the spring element may still be generally designed as a single-layer disk spring, so that the manufacturing complexity and the manufacturing costs for the spring element, and thus for the entire anchor, may be particularly low. In particular, no complex spring packages according to DE 33 31 097 A1 are generally needed, and very good load values in cracked concrete may nevertheless be obtained. Moreover, sufficient residual pretensions may be achieved according to the present invention in relatively large cracks, which may occur, for example, in seismic situations.

When the spring element has completed its maximum spring deflection, i.e., when spring deflection s is thus s=sₘₐₓ, the spring element is deflected up to a hard stop and/or its deformation path is exhausted. In particular, the spring characteristic curve may bend very steeply upwardly at maximum spring deflection sₘₐₓ. A slackening of 0.4 mm to 0.8 mm from the maximum spring deflection may involve, in particular, that the spring element has rebounded away from this maximum spring deflection by this distance, so that the following also applies to spring deflection s:

(sₘₐₓ−0.8 mm)<s<(sₘₐₓ−0.4 mm).

In principle, it may be sufficient if axial spring force F of the spring element is in the range of 0.4 mm to 0.8 mm from the maximum spring deflection in the range of Fₘᵢₙ<F<Fₘₐₓ at least in one single position, and therefore if Fₘᵢₙ<F<Fₘₐₓ applies to at least one spring deflection s in the range of (sₘₐₓ−0.8 mm)<s<(sₘₐₓ−0.4 mm). In this case, the present invention defines a line in the load displacement diagram which is cut from the spring characteristic curve of the spring element. However, it is particularly preferred if axial spring force F of the spring element is deflected from the maximum spring deflection over the entire range of 0.4 mm to 0.8 mm, i.e., it is in the range of Fₘᵢₙ<F<Fₘₐₓ for each spring deflection s in the range of (sₘₐₓ−0.8 mm)<s<(sₘₐₓ−0.4 mm). The present invention then defines a rectangle in the load displacement diagram, in which the spring characteristic curve of the spring element must lie. A particularly reliable anchor in cracked concrete may be obtained hereby.

The spring element according to the present invention is, in particular, a compression spring, i.e., a spring which generates an axial spring force during axial compression. To the extent that “radial,” “axial” and “circumferential direction” are mentioned in this description, this may apply, in particular, to the longitudinal axis of the bolt, which may be, in particular, the axis of symmetry and/or the center axis of the bolt. The diameter of the bolt, in particular maximum diameter dₘₐₓ of the bolt, is preferably measured perpendicularly to the longitudinal axis of the bolt. Maximum diameter dₘₐₓ of the bolt preferably corresponds approximately to the nominal diameter of the expansion anchor, i.e., in particular the diameter of the drilled hole provided for the expansion anchor.

The expansion anchor may preferably be a torque-controlled expansion anchor. According to the present invention, the expansion sleeve is situated, in particular fastened, on the bolt, movable along the bolt. The expansion sleeve and/or the bolt is/are suitably made of a metal material which, for example, may also be coated to influence the friction in a targeted manner.

According to the present invention, the expansion sleeve is pushed radially outwardly from an inclined surface of the expansion cone and pressed against the drilled hole wall in the substrate when the expansion cone is axially displaced relative to the expansion sleeve in the extraction direction of the bolt. This anchors the expansion anchor in the drilled hole. The extraction direction preferably runs in parallel to the longitudinal axis of the bolt and/or points out of the drilled hole. The distance of the surface of the expansion cone from the longitudinal axis of the bolt advantageously increases counter to the extraction direction, i.e., its distance increases from the rear end of the bolt. The surface of the expansion cone may be, but is not necessarily, strictly conical.

The counter bearing advantageously forms a shoulder, in particular an annular step, at which the counter bearing may counteract the attachment part in a form-fitting manner. In particular, tensile forces which are oriented in the extraction direction may, in particular, be introduced into the bolt. The counter bearing may have an outer polygon, for example and outer hexagon, facing the tool attachment. In particular, if the expansion anchor is designed as a so-called sleeve anchor, the counter bearing may be provided axially fixedly and rotatably fixedly on the bolt and, in particular, form a single piece therewith. In particular, if the expansion anchor is designed as a so-called bolt anchor, however, the counter bearing may also be a separate part from the bolt, which may be displaced axially relative to the bolt, for example by rotation. The counter bearing is preferably made of a metal material.

According to the present invention, the counter bearing axially counteracts the spring element when the anchor is set, so that the spring element is clamped between the counter bearing and the attachment part. The spring element is preferably situated on the counter bearing, on the one hand, and on the attachment part, on the other hand, at least indirectly in each case. In particular, the spring element may encompass the bolt. The spring element is preferably made of a metal material. In particular, residual spring force F may be in the range between 2.5 kN and 7 KN after axial slackening of 0.4 mm to 0.8 mm from the maximum spring deflection.

As mentioned above, it may be particularly advantageous that the spring element is a single-layer disk spring. In particular, according to the present invention, exactly one spring element, designed as a single-layer disk spring, may be provided for axial pretensioning of the counter bearing against the attachment part. The disk spring may encompass the bolt, preferably in an annular manner. The disk spring may be configured in such a way that it is flat upon reaching the maximum spring deflection. However, it may also have one or multiple supporting elements, so that it is not fully flat upon deflection up to a hard stop, i.e., upon reaching the maximum spring deflection.

It may be provided that the expansion anchor has a washer, which encompasses the bolt and/or which is preferably situated between the spring element and the counter bearing. The washer is therefore preferably provided on the side of the spring element facing the rear end of the bolt. A washer of this type may further increase the reliability of the system, in particular in that it ensures a particularly accurate spring characteristic curve, for example by decoupling the torsion forces on the counter bearing from the spring element. Alternatively or additionally, a washer may be provided between the attachment part and the spring element, i.e., on the side of the spring element facing the front end of the bolt. Multiple washers may also be provided. However, the washer may also be dispensed with for a particularly cost-effective design. In particular, the spring element may directly abut the attachment part and/or the counter bearing.

In a so-called bolt anchor, the expansion cone may be axially fixedly situated on the bolt. When setting the anchor, the expansion cone is then drawn into the expansion sleeve by a shared axial movement of the bolt and the expansion cone relative to the expansion sleeve. The expansion cone preferably forms a single piece with the bolt. In a so-called sleeve anchor, the expansion cone may alternatively be a separate part from and preferably be connected to the bolt via a corresponding thread. The drawing of the expansion cone into the expansion sleeve when setting the anchor may then be preferably at least partially effectuated by a rotation of the bolt relative to the expansion cone, which is converted into an axial movement of the expansion cone relative to the bolt by a spindle drive, which is formed by the corresponding threads.

It is particularly preferred, in particular in a bolt anchor, that the bolt have a male thread in the area of its rear end, and the counter bearing be a nut which is screwed onto the male thread. The nut therefore has a female thread corresponding to the male thread of the bolt. Due to an arrangement of this type, a bolt anchor may be particularly easily set and pretensioned by applying a torque to the nut.

The present invention may be preferably used in bolt anchors, in which the expansion sleeve does not reach the drilled hole top. In this case, in particular, the bolt may have a stop, which delimits a displacement of the expansion sleeve away from the expansion cone, i.e., a displacement in the extraction direction. A stop of this type may particularly easily ensure that the expansion sleeve reliably penetrates the drilled hole together with the bolt. The stop is preferably formed by an annular collar, which may be advantageous with regard to manufacturing and reliability. In particular, the stop may be situated axially between the expansion cone and the counter bearing.

According to the present invention, maximum diameter dₘₐₓ of the bolt between the expansion cone and the counter bearing is determined, i.e., offset to the expansion cone and offset to the counter bearing. Maximum diameter dₘₐₓ of the bolt between the expansion cone and the counter bearing may preferably be a global maximum. Maximum diameter dₘₐₓ of the bolt between the expansion cone and the counter bearing may occur, in particular, on the thread or on the annular collar of the bolt. It is particularly preferred, therefore, that maximum diameter dₘₐₓ of the bolt between the expansion cone and the counter bearing be the thread outer diameter of the thread of the bolt.

It may be advantageously provided that the expansion sleeve has at least one expansion slot. The expansion slot may separate two adjacent expansion segments of the expansion sleeve. The expansion slot starts at the front end of the expansion sleeve and may facilitate the deformation of the expansion sleeve.

The present invention is used, in particular, in bolts in which dₘₐₓ>4 mm, since, in this case, Fₘᵢₙ>0 kN.

The present invention also relates to a set expansion anchor, in which the expansion anchor is anchored in the drilled hole, the spring element pretensioning the counter bearing of the bolt against the attachment part. The spring element abuts the attachment part at least indirectly, preferably directly. The spring element is suitably situated axially between the substrate and the counter bearing and/or outside the drilled hole, at least in areas, preferably completely. The set anchor is advantageously inserted into the drilled hole in the substrate through a recess, preferably a hole, in the attachment part.

### BRIEF DESCRIPTION OF THE DRAWINGS

The present invention is explained in greater detail below on the basis of preferred exemplary embodiments, which are represented schematically in the attached figures, it being possible, in principle, to implement individual features of the exemplary embodiments illustrated below individually or in any arbitrary combination within the scope of the present invention. The following are illustrated schematically:

FIG. 1 shows a longitudinal sectional view of an expansion anchor according to the present invention, set in a concrete substrate;

FIG. 2 shows a load displacement diagram, including a spring characteristic curve according to the present invention, for an expansion anchor according to FIG. 1, where dₘₐₓ=12 mm, the geometric state of the spring element (completely slackened, partially slackened or flat) additionally being shown schematically;

FIG. 3 shows a graph, in which dashed lines show the relations according to the present invention for Fₘᵢₙ and Fₘₐₓ, and in which points connected by solid lines show experimentally ascertained, particularly advantageous limiting values for Fₘᵢₙ and Fₘₐₓ;

FIG. 4 shows a partially longitudinal sectional view of an expansion anchor according to the present invention, set in a concrete substrate, according to a second specific embodiment; and

FIG. 5 shows a partially longitudinal sectional view of an expansion anchor according to the present invention, set in a concrete substrate, similar to FIG. 1 but without a washer.

### DETAILED DESCRIPTION

Elements having the same functions are identified by the same reference numerals in the figures.

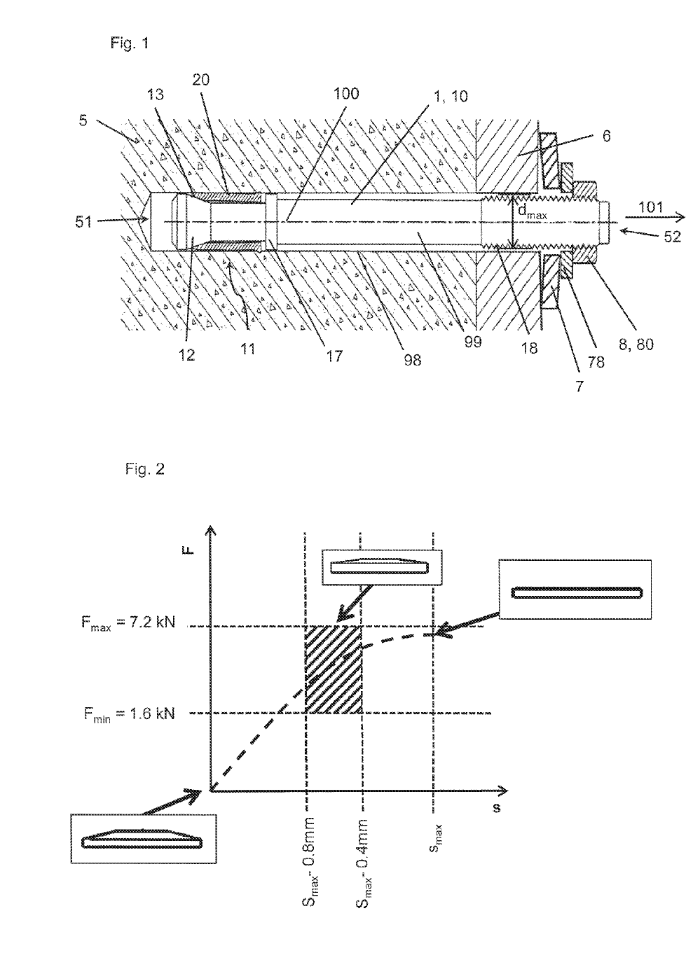

FIG. 1 shows an exemplary embodiment of an expansion anchor 1 according to the present invention. Illustrated expansion anchor 1 includes a bolt 10 and an expansion sleeve 20, expansion sleeve 20 encompassing bolt 10 in an annular manner. Bolt 10 includes an expansion cone 12 for expansion sleeve 20 in the area of its front end 51, which is continuously abutted by a neck area 11 toward the rear.

Bolt 10 has an essentially constant cylindrical cross section in neck area 11. The surface of bolt 10 is designed as a bevel 13 at adjacent expansion cone 12, and the diameter of bolt 10 here increases in the direction of first end 51, i.e., bolt 10 widens at expansion cone 12 from neck area 11 in the direction of its front first end 51. Bevel 13 on expansion cone 12 may be, but frequently is not necessarily, be conical in the strictly mathematical sense.

On the side of neck area 11 facing away from expansion cone 12, bolt 10 has a stop 17, designed as an annular collar, for expansion sleeve 20. In the area of its rear end 52, bolt 10 has a male thread 18 for introducing tensile forces into bolt 10. A nut 80, which forms an axial counter bearing 8, is situated on this male thread 18. Nut 80 is provided with an outer polygon, in particular an outer hexagon, and a female thread, which corresponds with male thread 18 of bolt 10.

Expansion anchor 1 in FIG. 1 furthermore includes a spring element 7, which encompasses bolt 10 in an annular manner and which is illustrated in FIG. 1 as a single-layer disk spring by way of example. Spring element 7, which is designed as a compression spring, is situated axially between substrate 5 and counter bearing 8, in particular axially between attachment part 6 and counter bearing 8 when the anchor is set and may thus pretension counter bearing 8 and thus bolt 10 axially with respect to substrate 5 and attachment part 6. Spring element 7 is thus situated on the side of counter bearing 8 facing front end 51 of bolt 10.

According to FIG. 1, a washer 78 is also provided between spring element 7 and counter bearing 8.

When expansion anchor 1 is set, bolt 10 is pushed into a drilled hole 99 in substrate 5 from FIG. 1 through a recess in attachment part 6 in the direction of longitudinal axis 100 of bolt 10, leading with its first end 51. Due to stop 17, which delimits a displacement of expansion sleeve 20 away from expansion cone 12, expansion sleeve 20 is also introduced into drilled hole 99. By tightening nut 80 forming counter bearing 8, bolt 10 is thus extracted a short distance from drilled hole 99 in extraction direction 101, which runs in parallel to longitudinal axis 100. Due to its friction on essentially cylindrical wall 98 of drilled hole 99, expansion sleeve 20 remains in drilled hole 99, and as a result a displacement of bolt 10 relative to expansion sleeve 20 occurs. During this displacement, bevel 13 of expansion cone 12 of bolt 10 penetrates deeper and deeper into expansion sleeve 20 in such a way that expansion sleeve 20 widens radially from bevel 13 in the area of its front end and is pressed against wall 98 of drilled hole 99. Due to this mechanism, expansion anchor 1 is fixed in substrate 5. Nut 80 preferably continues to be tightened until spring element 7 is completely compressed, i.e., it has reached its maximum spring deflection sₘₐₓ. An axial target pretension in bolt 10 is associated therewith.

If a crack opens in a substrate 5 made of cracked concrete in the surroundings of expansion anchor 1 after the anchor is set, expansion cone 12, and thus bolt 10, may under certain circumstances move together with expansion sleeve 20 a short distance in extraction direction 101, relative to substrate 5. In this case, spring element 7 may ensure that the pretension in bolt 10 is maintained to an adequate extent.

An example of a spring characteristic curve of spring element 7 is illustrated in FIG. 2. As shown in FIG. 2, the present invention may specify an area for example dₘₐₓ=12 mm, illustrated by the cross-hatching in FIG. 2, in which the spring characteristic curve must be situated when the spring element is slackened axially 0.4 mm to 0.8 mm away from its maximum spring deflection sₘₐₓ, which corresponds to a distance which typically occurs when a crack opens in cracked concrete. If the spring characteristic curve is in the aforementioned cross-hatched area, it may provide a sufficiently great residual pretension in the event of a typical crack opening in cracked concrete for the purpose of preventing an undesirable detachment of the anchoring and thus an undesirable axial movement of bolt 10 in extraction direction 101. In addition, spring element 7 may also be designed as a single spring, thus minimizing the use of materials.

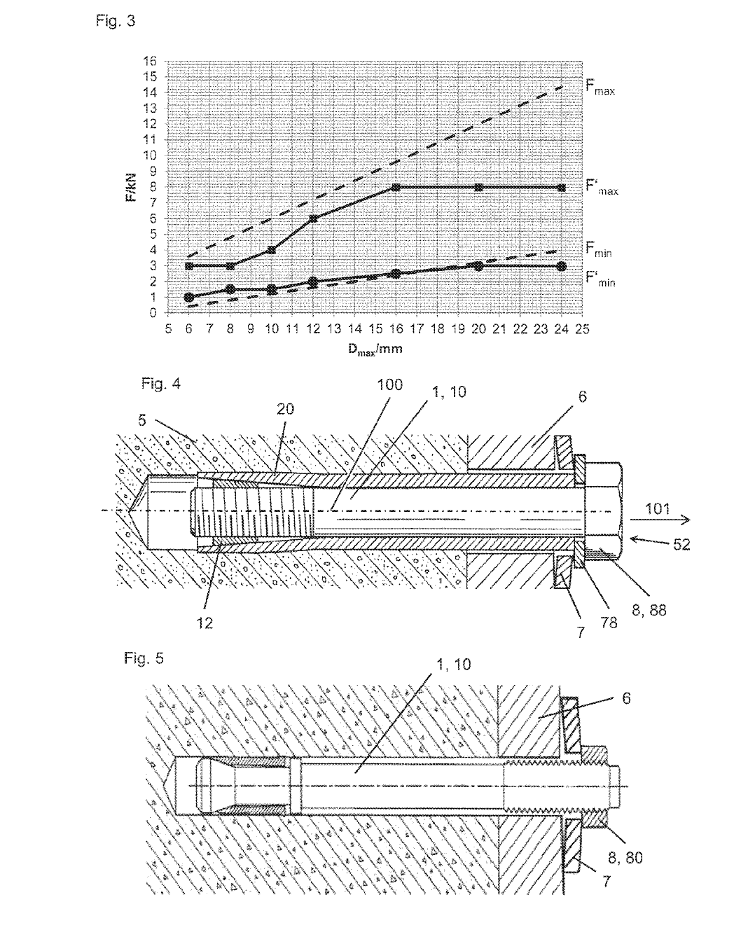

FIG. 3 shows a diagram having possible limiting values Fₘᵢₙ and Fₘₐₓ for residual spring force F during the slackening of 0.4 mm to 0.8 mm from the maximum spring deflection for various dₘₐₓ values. The dashed lines illustrate the relationships according to the present invention

Fₘᵢₙ=dₘₐₓ×0.2 kN/mm−0.8 kN (lower dashed line in FIG. 3)

and

Fₘₐₓ=dₘₐₓ×0.6 kN/mm (upper dashed line in FIG. 3).

The points connected by solid lines indicate values for (circular points, bottom) and F′ₘₐₓ (square points, top), which have proven to be particularly useful in experiments. As shown in FIG. 3, the aforementioned relationships for Fₘᵢₙ and Fₘₐₓ are linear approximations of these experimental points. The points illustrated in FIG. 3 and their linear connecting lines may also define Fₘᵢₙ and Fₘₐₓ instead of the relationships. As illustrated in FIG. 1, maximum bolt diameter dₘₐₓ between expansion cone 12 and counter bearing 8, which forms the abscissa in FIG. 3, may be, in particular, the thread outer diameter of male thread 18 of bolt 10.

In the exemplary embodiment in FIG. 1, expansion anchor 1 is designed as a so-called bolt anchor. FIG. 4 shows another exemplary embodiment, in which expansion anchor 1 is designed as a so-called sleeve anchor. In contrast to the bolt anchor from FIG. 1, in which expansion cone 12 is axially fixedly provided on bolt 10 and, in particular, forms a single piece with bolt 10, expansion cone 12 in the sleeve anchor in FIG. 4 is a separate part from bolt 10. It has a female thread, which corresponds with a male thread on bolt 10. In the sleeve anchor in FIG. 4, expansion sleeve 20, which may also include multiple parts, furthermore extends up to the drilled hole top, and counter bearing 8 on the rear end of bolt 10 is designed as screw head 88, is rotatably fixedly and axially fixedly situated on bolt 10 and, in particular, forms a single piece with bolt 10.

To set the anchor in FIG. 4, bolt 10 is rotated around longitudinal axis 100 with the aid of screw head 88. The corresponding thread converts this rotational movement of bolt 10 into an axial movement of expansion cone 12, relative to bolt 10 and thus relative to expansion sleeve 20, which results in the retraction of expansion cone 12 into expansion sleeve 20.

A spring element 7 is also provided in the exemplary embodiment in FIG. 4, which is able to pretension counter bearing 8, and thus bolt 10, against substrate 5 and/or attachment part 6. The characteristic curve of spring element 7 of the anchor from FIG. 4 is suitably also designed as explained in connection with FIGS. 2 and 3.

In the exemplary embodiments in FIGS. 1 and 4, a washer 78 is provided between spring element 7 and counter bearing 8. However, this washer 78 may also be dispensed with. FIG. 5 shows an exemplary embodiment without a washer. With the exception of the lack of the washer, this exemplary embodiment corresponds to the one in FIG. 1.

Since there is no washer in the exemplary embodiment in FIG. 5, spring element 7 here directly abuts counter bearing 8. The characteristic curve of spring element 7 of the anchor from FIG. 5 is suitably also designed as explained in connection with FIGS. 2 and 3. The process of setting the anchor from FIG. 5 may take place as explained in connection with FIG. 1.

Washer 78 may also be dispensed with in the exemplary embodiment in FIG. 4, so that spring element 7 in that case may also directly abut counter bearing 8.

1-6. (canceled)

7. An expansion anchor for anchoring in a drilled hole in a substrate, the expansion anchor comprising:
a bolt having a front end and a rear end opposite the front end;
an expansion sleeve situated on the bolt;
an expansion cone situated in an area of the front end of the bolt and pushing the expansion sleeve radially outwardly when the expansion cone is offset in an extraction direction relative to the expansion sleeve;
a counter bearing for axially pressing an attachment part against the substrate, the counter bearing being situated on the bolt in an area of the rear end of the bolt; and
a spring element, situated on the bolt, for axially pretensioning the counter bearing against the attachment part, an axial spring force F of the spring element being in the range of
Fₘᵢₙ<F<Fₘₐₓ, where
Fₘᵢₙ=dₘₐₓ×0.2 kN/mm−0.8 kN and
Fₘₐₓ×0.6 kN/mm
when the spring element is axially slackened 0.4 mm to 0.8 mm from its maximum spring deflection, dₘₐₓ being a maximum diameter of the bolt between the expansion cone and the counter bearing.

8. The expansion anchor as recited in claim 7 wherein the spring element is a single-layer disk spring.

9. The expansion anchor as recited in claim 7 further comprising a washer encompassing the bolt and situated between the spring element and the counter bearing.

10. The expansion anchor as recited in claim 7 wherein the bolt has a male thread in the area of the rear end, the counter bearing being a nut screwed onto the male thread.

11. The expansion anchor as recited in claim 10 wherein a maximum diameter dₘₐₓ of the bolt between the expansion cone and the counter bearing is a thread outer diameter of the male thread of the bolt.

12. The expansion anchor as recited in claim 7 wherein the expansion anchor is anchored in the drilled hole, the spring element pretensioning the counter bearing of the bolt against the attachment part.
